(19) United States
(12) Patent Application Publication
(10) Pub. No.: US 2007/0202438 A1
(43) Pub. Date: Aug. 30, 2007

(54) Light sensitive planographic printing plate material and its manufacturing process

(75) Inventor: Yasuhiko Takamuki, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA MEDICAL & GRAPHIC, INC., Tokyo (JP)

(21) Appl. No.: 11/707,207

(22) Filed: Feb. 15, 2007

(30) Foreign Application Priority Data
Feb. 24, 2006 (JP) JP2006-048117

(51) Int. Cl. G03C 1/00

(52) U.S. Cl. 430/270.1

(57) ABSTRACT

Disclosed is a light sensitive planographic printing plate material comprising a support and provided thereon, a photopolymerizable light sensitive layer containing a siloxane surfactant and a protective layer containing one or more kinds of water-soluble polymers in that order, contact and of 25° C. water to the light sensitive layer being in the range of 65 to 85°, wherein one of the water soluble polymers is polyvinyl alcohol having a degree of saponification of not less than 94 mol %.

This application is based on Japanese Patent Application No. 2006-048117 file on Feb. 24, 2006 in Japanese Patent Office, the entire content of which is hereby incorporated by reference.

### FIELD OF THE INVENTION

The present invention relates to a light sensitive planographic printing plate material and its manufacturing process, particularly to a light sensitive planographic printing plate material for a computer to plate (CTP) system, and its manufacturing process.

### BACKGROUND OF THE INVENTION

Presently, in the process of manufacturing a printing plate for off-set printing, a computer to plate (CTP) system, has been developed, in which digital images are written directly on a light sensitive planographic printing plate material employing laser, and put into practical use.

In printing fields where relatively high printing durability is required, it is known that a light sensitive planographic printing plate material, comprising an aluminum plate as a support and provided thereon, an image formation layer, is used (see for example, Japanese Patent O.P.I. Publication Nos. 11-125897, 11-268413, 11-348446 and 2000-131828).

In the light sensitive planographic printing plate material for CTP system, a protective layer having an oxygen-shielding function is required and polyvinyl alcohol is used in the protective layer. A protective layer containing polyvinyl alcohol provides high sensitivity and latent image regression resistance due to its high oxygen-shielding function, however, adhesion of the protective layer to a light sensitive layer provided thereunder is lowered. In order to improve adhesion of the protective layer to the light sensitive layer, there are known methods for adjusting contact angle of the light sensitive layer, for example, that at printing (see for example, Japanese Patent O.P.I. Publication No. 8-286379), that at development (see for example, Japanese Patent O.P.I. Publication No. 2005-148196), and that of the light sensitive layer before provision of the protective layer (see for example, Japanese Patent O.P.I. Publication No. 10-10742), or a method employing a specific surfactant in the protective layer or adjusting the surfactant content of the protective layer. It has been found that these methods have great sensitivity variation due to humidity, although they improve the adhesion.

### SUMMARY OF THE INVENTION

An object of the invention is to provide a light sensitive planographic printing plate material with high latent image regression resistance and less sensitivity variation due to humidity, comprising a light sensitive layer and provided thereon, a protective layer with good coatability and good adhesion to the light sensitive layer, and its manufacturing process.

### DETAILED DESCRIPTION OF THE INVENTION

The above object of the invention can be attained by any one of the following constitutions.

1. A light sensitive planographic printing plate material comprising a support and provided thereon, a photopolymerizable light sensitive layer containing a siloxane surfactant and a protective layer containing one or more kinds of water-soluble polymers in that order, contact angle of 25° C. water to the light sensitive layer being in the range of 65 to 85°, wherein one of the water soluble polymers is polyvinyl alcohol having a degree of saponification of not less than 94 mol %.

2. The light sensitive planographic printing plate material of item 1 above, wherein the protective layer further contains polyvinyl pyrrolidone or vinyl pyrrolidone copolymer.

3. The light sensitive planographic printing plate material of item 1 above, wherein the siloxane surfactant is polyether modified dimethylpolysiloxane.

4. The light sensitive planographic printing plate material of item 3 above, wherein the polyether modified dimethylpolysiloxane is dimethylpolysiloxane modified with polyethylene oxide, polypropylene oxide, polybutylene oxide or their combination.

5. The light sensitive planographic printing plate material of item 1 above, wherein the siloxane surfactant content of the light sensitive layer is from 0.01 to 10% by weight.

6. The light sensitive planographic printing plate material of item 1 above, wherein the polyvinyl alcohol content of the protective layer is from 65 to 85% by weight.

7. The light sensitive planographic printing plate material of item 1 above, wherein the photopolymerizable light sensitive layer contains a polymeric binder having an acid value of from 30 to 120, a polymerizable ethylenically unsaturated compound, and a photopolymerization initiator.

8. The light sensitive planographic printing plate material of item 7 above, wherein the polymerizable ethylenically unsaturated compound is a reaction product of (a) a polyhydric alcohol having a tertiary amino group in the molecule, (b) a diisocyanate and (c) a compound having a hydroxyl group and an ethylenically double bond in the molecule, and the photopolymerization initiator is selected from the group consisting of a titanocene compound, an iron-arene complex, a trihaloalkyl compound and a monoalkyltriaryl borate compound.

9. The light sensitive planographic printing plate material of item 1 above, wherein the photopolymerizable light sensitive layer further contains a sensitizing dye.

10. A process for manufacturing the light sensitive planographic printing plate material of item 1 above, the process the steps of forming a photopolymerizable light sensitive layer containing a siloxane surfactant on a support, providing a protective layer coating liquid containing one or more kinds of water-soluble polymers, one of the water soluble polymers being polyvinyl alcohol having a degree of saponification of not less than 94 mol %, coating the protective layer coating liquid on the resulting light sensitive layer, and drying the coated protective layer at 95 to 120° C. to form a protective layer on the light sensitive layer.

The invention will be explained in detail below.

The light sensitive planographic printing plate material of the invention comprises a support and provided thereon, a photopolymerizable light sensitive layer containing a siloxane surfactant and a protective layer containing one or more kinds of water-soluble polymers in that order, contact angle of 25° C. water to the light sensitive layer being in the range of 65 to 85°, wherein one of the water soluble polymers is polyvinyl alcohol having a degree of saponification of not less than 94 mol %.

In the invention, contact angle of 25° C. water to light sensitive layer is determined according to the following procedures. Water of 25° C. is dropped on a light sensitive layer at 25° C. and 50% RH to from a water drop, and 30 second after, angle on the water drop side between the light sensitive layer and the tangent to the water drop at the point at which the light sensitive surface crosses the outer periphery of the water drop is measured as contact angle of 25° C. water (hereinafter referred to simply as contact angle) to light sensitive layer. A light sensitive layer having a contact angle exceeding 85° lowers coatability or adhesion of the protective layer and latent image regression resistance, and increases sensitivity variation due to humidity. In the invention, the contact angle can be adjusted by varying kinds or content of surfactants. In the invention, a siloxane surfactant is preferably used as surfactants. As the siloxane surfactant, polyether modified dimethylpolysiloxane is preferred. Examples of the polyether modified dimethylpolysiloxane include dimethylpolysiloxane modified with polyethylene oxide, polypropylene oxide, polybutylene oxide or their combination, the degree of modification being varied.

The siloxane surfactants are available on the market. There are, for example, BYK-302, BYK-306, BYK-307, BYK-320, BYK-323, BYK-330, BYK-331, BYK-333, BYK-337, BYK-340, BYK-344, BYK-370, BYK-375 BYK-377, and BYK-UV3500, each produced by BYK Chemie Co., Ltd.; KF-945, KF-352A, KF-640, KF-351A, KF-354L, KF-640, X-22-4272, and X-22-6266, each produced by Shinetsu Chemical Co., Ltd.; and EFKA-3030, EFKA-3031, EFKA-3034, EFKA-3299, EFKA-3232, EFKA-3288, EFKA-3033, EFKA-3035, EFKA-3580, EFKA-3883, EFKA-3239, EFKA-3236, and EFKA-3522, each produced by EFKA Co., Ltd.

The content of the siloxane surfactants in the light sensitive layer is preferably from 0.01 to 10% by weight, and more preferably from 0.05 to 2% by weight, based on the weight of the light sensitive layer.

The protective layer in the invention contains polyvinyl alcohol (hereinafter also referred to as polyvinyl alcohol in the invention) having a degree of saponification of not less than 94 mol %. The polyvinyl alcohol in the invention has a degree of polymerization of preferably from 300 to 2400. The polyvinyl alcohol in the invention may be modified with a cationic group, an anionic group or a reactive group. In the invention, when two or more kinds of polyvinyl alcohols having a different degree of saponification are used in the protective layer, the polyvinyl alcohols are contained in the protective layer to obtain a degree of saponification of not less than 94 mol %. It is preferred in the invention that a single polyvinyl alcohol having a degree of saponification of not less than 94 mol % is used. Use of polyvinyl alcohol having a degree of saponification of less than 94 mol % lowers latent image regression resistance.

The term “degree of saponification” is technical term generally used in the polymer science. In the invention, “degree of saponification” is defined as follows:

Degree of Saponification (mol %)=m×100/(m+n)

wherein m and n independently represent a number of mole in polyvinyl alcohol having the following chemical structure:

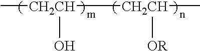

wherein R represents a substituent, usually an acetyl group.

Examples of the polyvinyl alcohol in the invention include PVA-102, PVA-103, PVA-104A, PVA-105, PVA-110, PVA-117, PVA-117H, PVA-120, PVA-124, PVA-124H, PVA-CS, PVA-CST, PVA-HC, PVA-203, PVA-204, PVA-205, PVA-210, PVA-217, PVA-220, PVA-224, PVA-217E, PVA-217EE, PVA-220E, PVA-224E, PVA-405, PVA-420, PVA-613, PVA-617, PVA-624, L-8, L-9, L-10, KL-118, KM-118, R-1130, R-2105, R-2130, M-115, MP-102, HP-H105 and HP-F117, each produced by Kuraray Co., Ltd.; Mowiol 15-79, Mowiol 13-85, Mowiol 4-88, Mowiol 5-88, Mowiol 8-88, Mowiol 18-88, Mowiol 23-88, Mowiol 26-88, Mowiol 40-88, Mowiol 47-88, Mowiol 56-88, Mowiol 30-92, Mowiol 3-96, Mowiol 15-96, Mowiol 3-98, Mowiol 4-98, Mowiol 6-98, Mowiol 10-98, Mowiol 20-98, Mowiol 56-98, Mowiol 15-99, and Mowiol 28-99, each produced by Kuraray Specialties Europe Co., Ltd.; and Celvol 125, Celvol 165, Celvol 103, Celvol 305, Celvol 107, Celvol 310, Celvol 325, Celvol 350, Celvol 418, Celvol 425, Celvol 502, Celvol 203, Celvol 205, Celvol 513, Celvol 523 and Celvol 540, each produced by Celanese Corporation.

The content of the polyvinyl alcohol in the invention in the protective layer is preferably from 60 to 100% by weight, and more preferably from 65 to 85% by weight, based on the weight of the protective layer.

The protective layer in the invention can contain a water-soluble polymer in addition to the polyvinyl alcohol as described above. The water-soluble polymer herein referred to implies a polymer having a weight average molecular weight of not less than 500 and a solubility to water of not less than 0.1, the solubility to water being represented by grams of polymer dissolving in 100 g of 25° C. water

Examples of the water-soluble polymers include a homopolymer or copolymer of hydroxystyrene, polyamide, polyvinyl pyrrolidone or vinyl pyrrolidone copolymer, polyethylene oxide, polyethylene imine, polyacrylic amide, core starch, mannan, pectin, agar, dextran, pullulan, glue, hydroxymethylcellulose, alginic acid, carboxymethylcellulose, and sodium polyacrylate. Among these, polyvinyl pyrrolidone or vinyl pyrrolidone copolymer is preferred.

In a process for manufacturing the light sensitive planographic printing plate material of the invention, the process comprises forming a light sensitive layer on a support, providing a protective layer coating liquid, coating the protective layer coating liquid on the light sensitive layer; and drying the coated protective layer at 95 to 120° C. to form a protective layer on the light sensitive layer. The drying temperature is preferably from 100 to 110° C. A drying temperature exceeding 120° C. tends to lower adhesion of the protective layer to the light sensitive layer, while a drying temperature lower than 95° C. tends to produce stains at non-image portions. Drying time is preferably from 10 to 300 seconds, and more preferably from 30 to 90 seconds.

In the invention, the protective layer coating liquid preferably contains a compound (an adhesive) exhibiting strong interaction with the light sensitive layer, high cohesion and giving high breakage resistance. AS such compounds, there are organic polymers which are soluble in water or in a mixture of water and an organic solvent miscible with water. Examples of the organic polymers include polyvinyl acetal, polyacrylic acid, polyacrylate, cross-linked sodium polyacrylate, isobutylene-maleic acid copolymer, modified polyester, modified polyamide, and polyvinyl pyrrolidone and its derivative. These compounds are available on the market, and typical examples thereof include AT series such as AT-163 and RHEOGIC series such as RHEOGIC 830, each produced by NIHON JUNYAKU Co., Ltd.; ISOBAN series such as ISOBAN 110 and 104, produced by Kuraray Co., Ltd.; Pesresin series such as A-115S and A-810, produced by Takamatsu Oil & Fat Co., Ltd.; AQ Nylon series such as P-70, produced by Toray Co., Ltd.; K series such as K-30, K-60, K-90, K-3375, I-3375, E-5355 and I-5355, produced by ISP JAPAN Co., Ltd.; and Luvitec series such as K-30, K-60, K-90, VA-64, and VA-64W, produced by BASF Co., Ltd. Among these, water-soluble polymers containing a nitrogen atom in the molecule are preferred as adhesives, and polyvinyl pyrrolidone or its derivatives produced by ISP JAPAN Co., Ltd. or BASF Co., Ltd. are more preferred.

The protective layer can optionally contain a surfactant or a matting agent. The protective layer is formed on a light sensitive layer by coating a protective layer coating solution containing the above described components on the light sensitive layer and drying it. Solvents for the protective layer coating solution are preferably water or alcohols such as methanol, ethanol and isopropanol.

The thickness of the protective layer is preferably from 0.7 to 2.0 mg/m², and more preferably from 1.3 to 2.0 mg/m².

The light sensitive layer of the light sensitive planographic printing plate material of the invention contains a polymeric binder, a polymerizable ethylenically unsaturated compound, a photopolymerization initiator, a siloxane surfactant, and preferably a sensitizing dye.

Next, the polymeric binder (hereinafter also referred to as the polymeric binder in the invention) will be explained.

As the polymeric binder in the invention can be used a polyacrylate resin, a polyvinylbutyral resin, a polyurethane resin, a polyamide resin, a polyester resin, an epoxy resin, a phenol resin, a polycarbonate resin, a polyvinyl butyral resin, a polyvinyl formal resin, a shellac resin, or another natural resin. These resins can be used as an admixture of two or more thereof.

The polymeric binder used in the invention is preferably a vinyl copolymer obtained by copolymerization of an acryl monomer, and more preferably a copolymer containing (i) a carboxyl group-containing monomer unit and (ii) an alkyl methacrylate or alkyl acrylate unit as the copolymerization component.

Examples of the carboxyl group-containing monomer include an α,β-unsaturated carboxylic acid, for example, acrylic acid, methacrylic acid, maleic acid, maleic anhydride, itaconic acid, itaconic anhydride or a carboxylic acid such as a half ester of phthalic acid with 2-hydroxymethacrylic acid.

Examples of the alkyl methacrylate or alkyl acrylate include an unsubstituted alkyl ester such as methylmethacrylate, ethylmethacrylate, propylmethacrylate, butylmethacrylate, amylmethacrylate, hexylmethacrylate, heptylmethacrylate, octylmethacrylate, nonylmethacrylate, decylmethacrylate, undecylmethacrylate, dodecylmethacrylate, methylacrylate, ethylacrylate, propylacrylate, butylacrylate, amylacrylate, hexylacrylate, heptylacrylate, octylacrylate, nonylacrylate, decylacrylate, undecylacrylate, or dodecylacrylate; a cyclic alkyl ester such as cyclohexyl methacrylate or cyclohexyl acrylate; and a substituted alkyl ester such as benzyl methacrylate, 2-chloroethyl methacrylate, N,N-dimethylaminoethyl methacrylate, glycidyl methacrylate, benzyl acrylate, 2-chloroethyl acrylate, N,N-dimethylaminoethyl acrylate or glycidyl acrylate.

The polymeric binder in the invention can further contain, as another monomer unit, a monomer unit derived from the monomer described in the following items (1) through (14):

(1) A monomer having an aromatic hydroxy group, for example, o-, (p- or m-) hydroxystyrene, or o-, (p- or m-) hydroxyphenylacrylate;

(2) A monomer having an aliphatic hydroxy group, for example, 2-hydroxyethyl acrylate, 2-hydroxyethyl methacrylate, N-methylolacrylamide, N-methylolmethacrylamide, 4-hydroxybutyl acrylate, 4-hydroxybutyl methacrylate, 5-hydroxypentyl acrylate, 5-hydroxypentyl methacrylate, 6-hydroxyhexyl acrylate, 6-hydroxyhexyl methacrylate, N-(2-hydroxyethyl)acrylamide, N-(2-hydroxyethyl)methacrylamide, or hydroxyethyl vinyl ether;

(3) A monomer having an aminosulfonyl group, for example, m- or p-aminosulfonylphenyl methacrylate, m- or p-aminosulfonylphenyl acrylate, N-(p-aminosulfonylphenyl)methacrylamide, or N-(p-aminosulfonylphenyl)acrylamide;

(4) A monomer having a sulfonamido group, for example, N-(p-toluenesulfonyl)acrylamide, or N-(p-toluenesulfonyl)-methacrylamide;

(5) An acrylamide or methacrylamide, for example, acrylamide, methacrylamide, N-ethylacrylamide, N-hexylacrylamide, N-cyclohexylacrylamide, N-phenylacrylamide, N-nitrophenylacrylamide, N-ethyl-N-phenylacrylamide, N-4-hydroxyphenylacrylamide, or N-4-hydroxyphenylmethacrylamide;

(6) A monomer having a fluorinated alkyl group, for example, trifluoromethyl acrylate, trifluoromethyl methacrylate, tetrafluoropropyl methacrylate, hexafluoropropyl methacrylate, octafluoropentyl acrylate, octafluoropentyl methacrylate, heptadecafluorodecyl methacrylate, heptadecafluorodecyl methacrylate, or N-butyl-N-(2-acryloxyethyl)heptadecafluorooctylsulfonamide;

(7) A vinyl ether, for example, ethyl vinyl ether, 2-chloroethyl vinyl ether, propyl vinyl ether, butyl vinyl ether, octyl vinyl ether, or phenyl vinyl ether;

(8) A vinyl ester, for example, vinyl acetate, vinyl chroloacetate, vinyl butyrate, or vinyl benzoate;

(9) A styrene, for example, styrene, methylstyrene, or chloromethylstyrene;

(10) A vinyl ketone, for example, methyl vinyl ketone, ethyl vinyl ketone, propyl vinyl ketone, or phenyl vinyl ketone;

(11) An olefin, for example, ethylene, propylene, isobutylene, butadiene, or isoprene;

(12) N-vinylpyrrolidone, N-vinylcarbazole, or N-vinylpyridine,

(13) A monomer having a cyano group, for example, acrylonitrile, methacrylonitrile, 2-pentenenitrile, 2-methyl-3-butene nitrile, 2-cyanoethyl acrylate, or o-, m- or p-cyanostyrene;

(14) A monomer having an amino group, for example, N,N-diethylaminoethyl methacrylate, N,N-dimethylaminoethyl acrylate, N,N-dimethylaminoethyl methacrylate, polybutadiene urethane acrylate, N,N-dimethylaminopropyl acrylamide, N,N-dimethylacrylamide, acryloylmorpholine, N-isopropylacrylamide, or N,N-diethylacrylamide.

Further another monomer may be copolymerized with the above monomer. As the polymeric binder is also preferred an unsaturated bond-containing copolymer which is obtained by reacting a carboxyl group contained in the above vinyl copolymer molecule with for example, a compound having a (meth)acryloyl group and an epoxy group. Examples of the compound having a double bond and an epoxy group in the molecule include glycidyl acrylate, glycidyl methacrylate and an epoxy group-containing unsaturated compound disclosed in Japanese Patent O.P.I. Publication No. 11-27196.

The weight average molecular weight of the above copolymer is preferably 10,000 to 200,000 measured by gel permeation chromatography (GPC), but is not limited thereto.

The content of the polymeric binder in the light sensitive layer is preferably from 10 to 90% by weight, more preferably from 15 to 70% by weight, and still more preferably from 20 to 50% by weight, in view of sensitivity.

The acid value of the polymeric binder is preferably from 10 to 150, more preferably from 30 to 120, and still more preferably from 50 to 90, in view of balance of polarity of the photopolymerizable light sensitive layer, which can prevent coagulation of pigment used in the photopolymerizable light sensitive layer coating liquid.

Next, the polymerizable ethylenically unsaturated compound (hereinafter also referred to as ethylenically unsaturated compound) will be explained.

As the ethylenically unsaturated compound in the invention, there are a known monomer such as a radically polymerizable monomer, and a polyfunctional monomer or oligomer having two or more of an ethylenic double bond in the molecule generally used in an ultraviolet curable resin composition. The monomers are not specifically limited.

Preferred examples thereof include a monofunctional acrylate such as 2-ethylhexyl acrylate, 2-hydroxypropyl acrylate, glycerol acrylate, tetrahydrofurfuryl acrylate, phenoxyethyl acrylate, nonylphenoxyethyl acrylate, tetrahydrofurfuryl-oxyethyl acrylate, tetrahydrofurfuryloxyhexanorideacrylate, an ester of 1,3-dioxane-ε-caprolactone adduct with acrylic acid, or 1,3-dioxolane acrylate; a methacrylate, itaconate, crotonate or maleate alternative of the above acrylate; a bifunctional acrylate such as ethyleneglycol diacrylate, triethyleneglycol diacrylate, pentaerythritol diacrylate, hydroquinone diacrylate, resorcin diacrylate, hexanediol diacrylate, neopentyl glycol diacrylate, tripropylene glycol diacrylate, hydroxypivalic acid neopentyl glycol diacrylate, neopentyl glycol adipate diacrylate, diacrylate of hydroxypivalic acid neopentyl glycol-ε-caprolactone adduct, 2-(2-hydroxy-1,1-dimethylethyl)-5-hydroxymethyl-5-ethyl-1,3-dioxane diacrylate, tricyclodecanedimethylol acrylate, tricyclodecanedimethylol acrylate-ε-caprolactone adduct or 1,6-hexanediol diglycidylether diacrylate; a dimethacrylate, diitaconate, dicrotonate or dimaleate alternative of the above diacrylate; a polyfunctional acrylate such as trimethylolpropane triacrylate, ditrimethylolpropane tetraacrylate, trimethylolethane triacrylate, pentaerythritol triacrylate, pentaerythritol tetraacrylate, dipentaerythritol tetraacrylate, dipentaerythritol pentaacrylate, dipentaerythritol hexacrylate, dipentaerythritol hexacrylate-ε-caprolactone adduct, pyrogallol triacrylate, propionic acid dipentaerythritol triacrylate, propionic acid dipentaerythritol tetraacrylate or hydroxypivalylaldehyde modified dimethylolpropane triacrylate; a methacrylate, itaconate, crotonate or maleate alternative of the above polyfunctional acrylate.

A prepolymer can be used as the ethylenically unsaturated compound, and examples of the prepolymer include compounds as described later. The prepolymer with a photopolymerizable property, which is obtained by incorporating acrylic acid or methacrylic in an oligomer with an appropriate molecular weight, can be suitably employed. These prepolymers can be used singly, in combination or as their mixture with the above described monomers and/or oligomers.

Examples of the prepolymer include polyester(meth)acrylate obtained by incorporating (meth)acrylic acid in a polyester of a polybasic acid such as adipic acid, trimellitic acid, maleic acid, phthalic acid, terephthalic acid, hymic acid, malonic acid, succinic acid, glutaric acid, itaconic acid, pyromellitic acid, fumalic acid, pimelic acid, sebatic acid, dodecanoic acid or tetrahydrophthalic acid with a polyol such as ethylene glycol, ethylene glycol, diethylene glycol, propylene oxide, 1,4-butane diol, triethylene glycol, tetraethylene glycol, polyethylene glycol, grycerin, trimethylol propane, pentaerythritol, sorbitol, 1,6-hexanediol or 1,2,6-hexanetriol; an epoxyacrylate such as bisphenol A.epichlorhydrin.(meth)acrylic acid or phenol novolak.epichlorhydrin.(meth)acrylic acid obtained by incorporating (meth)acrylic acid in an epoxy resin; an urethaneacrylate such as ethylene glycol.adipic acid.tolylenediisocyanate.2-hydroxyethylacrylate, polyethylene glycol.tolylenediisocyanate.2-hydroxyethylacrylate, hydroxyethylphthalyl methacrylate.xylenediisocyanate, 1,2-polybutadieneglycol.tolylenediisocyanate.2-hydroxyethylacrylate or trimethylolpropane.propylene glycol.tolylenediisocyanate.2-hydroxyethylacrylate, obtained by incorporating (meth)acrylic acid in an urethane resin; a silicone acrylate such as polysiloxane acrylate, or polysiloxane.diisocyanate.2-hydroxyethylacrylate; an alkyd modified acrylate obtained by incorporating a methacroyl group in an oil modified alkyd resin; and a spiran resin acrylate.

The light sensitive layer in the invention may contain a monomer such as a phosphazene monomer, triethylene glycol, an EO modified isocyanuric acid diacrylate, an EO modified isocyanuric acid triacrylate, dimethyloltricyclodecane diacrylate, trimethylolpropane acrylate benzoate, an alkylene glycol acrylate, or a urethane modified acrylate, or an addition polymerizable oligomer or prepolymer having a structural unit derived from the above monomer.

The ethylenic monomer used in combination is preferably a phosphate compound having at least one (meth)acryloyl group. The phosphate compound is a compound having a (meth)acryloyl group in which at least one hydroxyl group of phosphoric acid is esterified, and the phosphate compound is not limited as long as it has a (meth)acryloyl group.

Besides the above compounds, compounds disclosed in Japanese Patent O.P.I. Publication Nos. 58-212994, 61-6649, 62-46688, 62-48589, 62-173295, 62-187092, 63-67189, and 1-244891, compounds described on pages 286 to 294 of “11290 Chemical Compounds” edited by Kagakukogyo Nipposha, and compounds described on pages 11 to 65 of “UV•EB Koka Handbook (Materials)” edited by Kobunshi Kankokai can be suitably used. Of these compounds, compounds having two or more acryl or methacryl groups in the molecule are preferable, and those having a molecular weight of not more than 10,000, and preferably not more than 5,000 are more preferable.

In the invention, an ethylenically unsaturated monomer having a tertiary amino group in the molecule is preferably used. Its molecular structure is not limited, but those are preferred in which a tertiary amine having a hydroxyl group is modified with glycidyl methacrylate, methacrylic chloride, or acrylic chloride. Examples thereof include a polymerizable compound disclosed in Japanese Patent O.P.I. Publication Nos. 1-165613, 1-203413 and 1-197213.

A reaction product of a polyhydric alcohol having (a) a tertiary amino group in the molecule, (b) a diisocyanate and (c) a compound having both hydroxyl group and ethylenically double bond in the molecule is more preferably used in the invention.

Examples of the polyhydric alcohol having a tertiary amino group in the molecule include triethanolamine, N-methyldiethanolamine, N-ethyldiethanolamine, N-ethyldiethanolamine, N-n-butyldiethanolamine, N-tert-butyldiethanolamine, N,N-di(hydroxyethyl)aniline, N,N,N′,N′-tetra-2-hydroxypropylethylenediamine, p-tolyldiethanolamine, N,N,N′,N′-tetra-2-hydroxyethylethylenediamine, N,N-bis(2-hydroxypropyl)aniline, allyldiethanolamine, 3-dimethylamino-1,2-propane diol, 3-diethylamino-1,2-propane diol, N,N-di(n-propylamino)-2,3-propane diol, N,N-di(iso-propylamino)-2,3-propane diol, and 3-(N-methyl-N-benzylamino)-1,2-propane diol, but the invention is not specifically limited thereto.

Examples of the diisocyanate include butane-1,4-diisocyanate, hexane-1,6-diisocyanate, 2-methylpentane-1,5-diisocyanate, octane-1,8-diisocyanate, 1,3-diisocyanatomethylcyclohexanone, 2,2,4-trimethylhexane-1,6-diisocyanate, isophorone diisocyanate, 1,2-phenylene diisocyanate, 1,3-phenylene diisocyanate, 1,4-phenylene diisocyanate, tolylene-2,4-diisocyanate, tolylene-2,5-diisocyanate, tolylene-2,6-diisocyanate, 1,3-di(isocyanatomethyl)benzene, and 1,3-bis(1-isocyanato-1-methylethyl)benzene, but the invention is not specifically limited thereto. Examples of the compound having both hydroxyl group and ethylenically double bond in the molecule include 2-hydroxyethyl methacrylate, 2-hydroxyethyl acrylate, 4-hydroxybutyl acrylate, 2-hydroxypropylene-1,3-dimethacrylate, and 2-hydroxypropylene-1-methacrylate-3-acrylate.

The reaction product above can be synthesized according to the same method as a conventional method in which a urethaneacrylate compound is ordinarily synthesized employing an ordinary diol, a diisocyanate and an acrylate having a hydroxyl group.

Examples of the reaction product of a polyhydric alcohol having a tertiary amino group in the molecule, a diisocyanate and a compound having a hydroxyl group and an ethylenically double bond in the molecule will be listed below.

### M-1: A reaction product of triethanolamine (1 mole), hexane-1,6-diisocyanate (3 moles), and 2-hydroxyethyl methacrylate (3 moles)

### M-2: A reaction product of triethanolamine (1 mole), isophorone diisocyanate (3 moles), and 2-hydroxyethyl methacrylate (3 moles)

### M-3: A reaction product of N-n-butyldiethanolamine (1 mole), 1,3-bis(1-cyanato-1-methylethyl)benzene (2 moles), and 2-hydroxypropylene-1-methacrylate-3-acrylate (2 moles)

### M-4: A reaction product of N-n-butyldiethanolamine (1 mole), 1,3-di(cyanatomethyl)benzene (2 moles), and 2-hydroxypropylene-1-methacrylate-3-acrylate (2 moles)

### M-5: A reaction product of N-methyldiethanolamine (1 mole), tolylene-2,4-diisocyanate (2 moles), and 2-hydroxypropylene-1,3-dimethacrylate (2 moles)

In addition to the above, acrylates or methacrylates disclosed in Japanese Patent O.P.I. Publication Nos. 1-105238 and 2-127404 can be used.

The ethylenically unsaturated compound content of the light sensitive layer is preferably from 1.0 to 80.0% by weight, and more preferably from 3.0 to 70.0% by weight.

Next, the photopolymerization initiator will be explained. As the photopolymerization initiator, there are a titanocene compound, an iron-arene complex, a trihaloalkyl compound and a monoalkyltriaryl borate compound.

### (Titanocene Compound)

As the titanocene compounds, there are those described in Japanese Patent O.P.I. Publication Nos. 63-41483 and 2-291. Preferred examples of titanocene compounds include bis(cyclopentadienyl)-Ti-di-chloride, bis(cyclopentadienyl)-Ti-bis-phenyl, bis(cyclopentadienyl)-Ti-bis-2,3,4,5,6-pentafluorophenyl, bis(cyclopentadienyl)-Ti-bis-2,3,5,6-tetrafluorophenyl, bis(cyclopentadienyl)-Ti-bis-2,4,6-trifluorophenyl, bis(cyclopentadienyl)-Ti-bis-2,6-difluorophenyl, bis(cyclopentadienyl)-Ti-bis-2,4-difluorophenyl, bis(methylcyclopentadienyl)-Ti-bis-2,3,4,5,6-pentafluorophenyl, bis(methylcyclopentadienyl)-Ti-bis-2,3,5,6-tetrafluorophenyl, bis(methylcyclopentadienyl)-Ti-bis-2,6-difluorophenyl (IRUGACURE 784, produced by Ciba Speciality Chemicals Co.), bis(cyclopentadienyl)-bis(2,4,6-trifluoro-3-(pyry-1-yl)phenyl)titanium, and bis(cyclopentadienyl)-bis(2,4,6-trifluoro-3-(2-5-dimethylpyry-1-yl)phenyl)titanium.

### (Iron-Arene Complex)

As the iron-arene complexes, there are those disclosed in Japanese Patent O.P.I. Publication No. 59-219307.

Preferred examples of the iron-arene complex include η-benzene-(η-cyclopentadienyl)iron hexafluorophosphate, η-cumene-(η-cyclopentadienyl)iron hexafluorophosphate, η-fluorene-(η-cyclopentadienyl)iron hexafluorophosphate, η-naphthalene-η-cyclopentadienyl)iron hexafluorophosphate, η-xylene-η-cyclopentadienyl)iron hexafluorophosphate, and η-benzene-η-cyclopentadienyl)iron tetrafluorophosphate.

### (Monoalkyltriaryl Borate Compound)

As the monoalkyltriaryl borate compounds, there are those described in Japanese Patent O.P.I. Publication Nos. 62-150242 and 62-143044. Preferred examples of the monoalkyltriaryl borate compounds include tetra-n-butyl ammonium n-butyl-trinaphthalene-1-yl-borate, tetra-n-butyl ammonium n-butyl-triphenyl-borate, tetra-n-butyl ammonium n-butyl-tri-(4-tert-butylphenyl)-borate, tetra-n-butyl ammonium n-hexyl-tri-(3-chloro-4-methylphenyl)-borate, and tetra-n-butyl ammonium n-hexyl-tri-(3-fluorophenyl)-borate.

### (Trihaloalkyl Compound)

As the trihaloalkyl compounds, those containing chlorine or bromine as halogen are preferred. The trihaloalkyl group is preferably a trihalomethyl group, and is bonded directly or through a conjugated chain to an aromatic hydrocarbon or heterocyclic ring. A compound having a triazine ring with two trihalomethyl groups is preferred, and compounds disclosed in EP-A-137,452, and DE-A-2,118,259 and 2,243,621 is especially preferred. These compounds have an absorption at near ultraviolet regions, for example, at wavelength regions from 350 to 400 nm. An initiator having little or no absorption at the spectral regions of the emitted light, for example, trihalomethyltriazine of mesomerism structure having a substituent or aliphatic group with a short conjugated system is suitably used. A compound having an absorption at far ultraviolet regions, for example, phenyl trihalomethyl sulfone (typically, phenyl tribromomethyl sulfone) or phenyl trihalomethyl ketone, is also suitably used.

Another photopolymerization initiator can be used in combination. Examples thereof include carbonyl compounds, organic sulfur compounds, peroxides, redox compounds, azo or diazo compounds, halides and photo-reducing dyes disclosed in J. Kosar, “Light Sensitive Systems”, Paragraph 5, and those disclosed in British Patent No. 1,459,563.

Typical examples of the photopolymerization initiator used in combination include the following compounds:

A benzoin derivative such as benzoin methyl ether, benzoin i-propyl ether, or α,α-dimethoxy-α-phenylacetophenone; a benzophenone derivative such as benzophenone, 2,4-dichlorobenzophenone, o-benzoyl methyl benzoate, or 4,4′-bis(dimethylamino)benzophenone; a thioxanthone derivative such as 2-chlorothioxanthone, 2-i-propylthioxanthone; an anthraquinone derivative such as 2-chloroanthraquinone or 2-methylanthraquinone; an acridone derivative such as N-methylacridone or N-butylacridone; α,α-diethoxyacetophenone; benzil; fluorenone; xanthone; an uranyl compound; a triazine derivative disclosed in Japanese Patent Publication Nos. 59-1281 and 61-9621 and Japanese Patent O.P.I. Publication No. 60-60104; an organic peroxide compound disclosed in Japanese Patent O.P.I. Publication Nos. 59-1504 and 61-243807; a diazonium compound in Japanese Patent Publication Nos. 43-23684, 44-6413, 47-1604 and U.S. Pat. No. 3,567,453; an organic azide compound disclosed in U.S. Pat. Nos. 2,848,328, 2,852,379 and 2,940,853; orthoquinondiazide compounds disclosed in Japanese Patent Publication Nos. 36-22062b, 37-13109, 38-18015 and 45-9610; various onium compounds disclosed in Japanese Patent Publication No. 55-39162, Japanese Patent O.P.I. Publication No. 59-14023 and “Macromolecules”, Volume 10, p. 1307 (1977); azo compounds disclosed in Japanese Patent Publication No. 59-142205; metal arene complexes disclosed in Japanese Patent O.P.I. Publication No. 1-54440, European Patent Nos. 109,851 and 126,712, and “Journal of Imaging Science”, Volume 30, p. 174 (1986); (oxo) sulfonium organoboron complexes disclosed in Japanese Patent O.P.I. Publication Nos. 5-213861 and 5-255347; titanocenes disclosed in Japanese Patent O.P.I. Publication Nos. 59-152396 and 61-151197; transition metal complexes containing a transition metal such as ruthenium disclosed in “Coordination Chemistry Review”, Volume 84, p. 85-277 (1988) and Japanese Patent O.P.I. Publication No. 2-182701; 2,4,5-triarylimidazol dimmer disclosed in Japanese Patent O.P.I. Publication No. 3-209477; carbon tetrabromide; organic halide compounds disclosed in Japanese Patent O.P.I. Publication No. 59-107344.

The content of the photopolymerization initiator in the light-sensitive layer is preferably from 0.1 to 20% by weight, and more preferably from 0.5 to 15% by weight, based on the amount of the ethylenically unsaturated compound contained in the light sensitive layer.

### (Sensitizing Dye)

The light sensitive layer of the planographic printing plate material of the invention preferably contains a sensitizing dye. The sensitizing dye is preferred which has an absorption maximum in the wavelength of light emitted from a light source used or in the vicinity of the wavelength.

Examples of the sensitizing dyes, which can induce sensitivity to the wavelengths of visible to near infrared regions, include cyanines, phthalocyanines, merocyanines, porphyrins, spiro compounds, ferrocenes, fluorenes, fulgides, imidazoles, perylenes, phenazines, phenothiazines, polyenes, azo compounds, diphenylmethanes, triphenylmethanes, polymethine acridines, cumarines, ketocumarines, quinacridones, indigos, styryl dyes, pyrylium dyes, pyrromethene dyes, pyrazolotriazole compounds, benzothiazole compounds, barbituric acid derivatives, thiobarbituric acid derivatives, ketoalcohol borate complexes, and compounds disclosed in European Patent No. 568,993, U.S. Pat. Nos. 4,508,811 and 5,227,227, and Japanese Patent O.P.I. Publication Nos. 2001-125255 and 11-271969.

Examples in which the above polymerization initiators are used in combination with the sensitizing dye are disclosed in Japanese Patent O.P.I. Publication Nos. 2001-125255 and 11-271969.

When a semiconductive laser having an emission wavelength in the regions of from 380 to 430 nm, so-called violet laser is used as a laser of a light source, it is preferred that the light sensitive layer contains a sensitizing dye having absorption maximum in the wavelength regions of from 350 to 450 nm. There are no specific limitations to its chemical structure of such a sensitizing dye, and the sensitizing dyes described above can be used as such a sensitizing dye, as long as they have absorption maximum in the wavelength regions of from 350 to 450 nm. These sensitizing dyes are disclosed in Japanese Patent O.P.I. Publication Nos. 2002-296764, 2002-268239, 2002-268238, 2002-268204, 2002-221790, 2002-202598, 2001-042524, 2000-309724, 2000-258910, 2000-206690, 2000-147763, and 2000-098605, but the invention is not limited thereto.

The sensitizing dye content of the light sensitive layer is preferably from 0.1 to 20% by weight, and more preferably from 0.1 to 10% by weight.

As the support used in light sensitive planographic printing plate material of the invention, an aluminum plate is preferred. The aluminum plate may be a pure aluminum plate or an aluminum alloy plate. As the aluminum alloy, there can be used various ones including an alloy of aluminum and a metal such as silicon, copper, manganese, magnesium, chromium, zinc, lead, bismuth, nickel, titanium, sodium or iron. An aluminum plate can be used which is manufactured according to various calender procedures. A regenerated aluminum plate can also used which is obtained by calendering ingot of aluminum material such as aluminum scrap or recycled aluminum.

It is preferable that the support in the invention is subjected to degreasing treatment for removing rolling oil prior to surface roughening (graining). The degreasing treatments include degreasing treatment employing solvents such as trichlene and thinner, and an emulsion degreasing treatment employing an emulsion such as kerosene or triethanol. It is also possible to use an aqueous alkali solution such as caustic soda for the degreasing treatment. When an aqueous alkali solution such as caustic soda is used for the degreasing treatment, it is possible to remove soils and an oxidized film which can not be removed by the above-mentioned degreasing treatment alone. When an aqueous alkali solution such as caustic soda is used for the degreasing treatment, the resulting support is preferably subjected to desmut treatment in an aqueous solution of an acid such as phosphoric acid, nitric acid, sulfuric acid, chromic acid, or a mixture thereof, since smut is produced on the surface of the support.

The surface roughening methods include a mechanical surface roughening method and an electrolytic surface roughening method electrolytically etching the support surface.

Though there is no restriction for the mechanical surface roughening method, a brushing roughening method and a honing roughening method are preferable. The brushing roughening method is carried out by rubbing the surface of the support with a rotating brush with a brush hair with a diameter of 0.2 to 0.8 mm, while supplying slurry in which volcanic ash particles with a particle size of 10 to 100 μm are dispersed in water to the surface of the support. The honing roughening method is carried out by ejecting obliquely slurry with pressure applied from nozzles to the surface of the support, the slurry containing volcanic ash particles with a particle size of 10 to 100 μm dispersed in water. A surface roughening can be also carried out by laminating a support surface with a sheet on the surface of which abrading particles with a particle size of from 10 to 100 μm was coated at intervals of 100 to 200 μm and at a density of 2.5×10³ to 10×10³/cm², and applying pressure to the sheet to transfer the roughened pattern of the sheet and roughen the surface of the support.

After the support has been roughened mechanically, it is preferably dipped in an acid or an aqueous alkali solution in order to remove abrasives and aluminum dust, etc. which have been embedded in the surface of the support. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, an aqueous alkali solution of for example, sodium hydroxide is preferably used. The dissolution amount of aluminum in the support surface is preferably 0.5 to 5 g/m². After the support has been dipped in the aqueous alkali solution, it is preferable for the support to be dipped in an acid such as phosphoric acid, nitric acid, sulfuric acid and chromic acid, or in a mixed acid thereof, for neutralization.

Though there is no restriction for the electrolytic surface roughening method, a method, in which the support is electrolytically surface roughened in an acidic electrolytic solution, is preferred. Though an acidic electrolytic solution generally used for the electrolytic surface roughening can be used, it is preferable to use an electrolytic solution of hydrochloric acid or that of nitric acid. The electrolytic surface roughening method disclosed in Japanese Patent Publication No. 48-28123, British Patent No. 896,563 and Japanese Patent O.P.I. Publication No. 53-67507 can be used. In the electrolytic surface roughening method, voltage applied is generally from 1 to 50 V, and preferably from 10 to 30 V. The current density used can be selected from the range from 10 to 200 A/dm², and is preferably from 50 to 150 A/dm². The quantity of electricity can be selected from the range of from 100 to 5000 C/dm², and is preferably 100 to 2000 C/dm². The temperature during the electrolytically surface roughening may be in the range of from 10 to 50° C., and is preferably from 15 to 45° C.

When the support is electrolytically surface roughened by using an electrolytic solution of nitric acid, voltage applied is generally from 1 to 50 V, and preferably from 5 to 30 V. The current density used can be selected from the range from 10 to 200 A/dm², and is preferably from 20 to 100 A/dm². The quantity of electricity can be selected from the range of from 100 to 5000 C/dm², and is preferably 100 to 2000 C/dm². The temperature during the electrolytically surface roughening may be in the range of from 10 to 50° C., and is preferably from 15 to 45° C. The nitric acid concentration in the electrolytic solution is preferably from 0.1% by weight to 5% by weight. It is possible to optionally add, to the electrolytic solution, nitrates, chlorides, amines, aldehydes, phosphoric acid, chromic acid, boric acid, acetic acid or oxalic acid.

When the support is electrolytically surface roughened by using an electrolytic solution of hydrochloric acid, voltage applied is generally from 1 to 50 V, and preferably from 2 to 30 V. The current density used can be selected from the range from 10 to 200 A/dm², and is preferably from 50 to 150 A/dm². The quantity of electricity can be selected from the range of from 100 to 5000 C/dm², and is preferably 100 to 2000 C/dm². The temperature during the electrolytically surface roughening may be in the range of from 10 to 50° C., and is preferably from 15 to 45° C. The hydrochloric acid concentration in the electrolytic solution is preferably from 0.1% by weight to 5% by weight. It is possible to optionally add, to the electrolytic solution, nitrates, chlorides, amines, aldehydes, phosphoric acid, chromic acid, boric acid, acetic acid or oxalic acid.

After the support has been electrolytically surface roughened, it is preferably dipped in an acid or an aqueous alkali solution in order to remove aluminum dust, etc. produced in the surface of the support. Examples of the acid include sulfuric acid, persulfuric acid, hydrofluoric acid, phosphoric acid, nitric acid and hydrochloric acid, and examples of the alkali include sodium hydroxide and potassium hydroxide. Among those mentioned above, the aqueous alkali solution is preferably used. The dissolution amount of aluminum in the support surface is preferably 0.5 to 5 g/m². After the support has been dipped in the aqueous alkali solution, it is preferable for the support to be dipped in an acid such as phosphoric acid, nitric acid, sulfuric acid and chromic acid, or in a mixed acid thereof, for neutralization.

The mechanical surface roughening and electrolytic surface roughening may be carried out singly, and the mechanical surface roughening followed by the electrolytic surface roughening may be carried out.

After the surface roughening, anodizing treatment may be carried out. There is no restriction in particular for the method of anodizing treatment used in the invention, and known methods can be used. The anodizing treatment forms an anodization film on the surface of the support. For the anodizing treatment there is preferably used a method of applying a current density of from 1 to 10 A/dm² to an aqueous solution containing sulfuric acid and/or phosphoric acid in a concentration of from 10 to 50%, as an electrolytic solution. However, it is also possible to use a method of applying a high current density to sulfuric acid as described in U.S. Pat. No. 1,412,768, a method to electrolytically etching the support in phosphoric acid as described in U.S. Pat. No. 3,511,661, or a method of employing a solution containing two or more kinds of chromic acid, oxalic acid, malonic acid, etc. The coated amount of the formed anodization film is suitably 1 to 50 mg/dm², and preferably 10 to 40 mg/dm². The coated amount of the formed anodization film can be obtained from the weight difference between the aluminum plates before and after dissolution of the anodization film. The anodization film of the aluminum plate is dissolved employing for example, an aqueous phosphoric acid chromic acid solution which is prepared by dissolving 35 ml of 85% by weight phosphoric acid and 20 g of chromium (IV) oxide in 1 liter of water.

The aluminum plate, which has been subjected to anodizing treatment, is optionally subjected to sealing treatment. For the sealing treatment, it is possible to use known methods using hot water, boiling water, steam, a sodium silicate solution, an aqueous dichromate solution, a nitrite solution and an ammonium acetate solution. After the above treatments, the resulting aluminum plate can be surface treated with polyvinyl phosphonic acid. As the surface treatment, there is for example, a coating method, a spraying method or a dipping method. The dipping method is preferred in that the facility is cheap.

The solution used in the dipping method is preferably an aqueous 0.01 to 35% polyvinyl phosphonic acid solution, and more preferably an aqueous 0.1 to 5% polyvinyl phosphonic acid solution. The treatment temperature is preferably from 20 to 90° C., and more preferably 40 to 80° C.

The treatment time is preferably from 10 to 180 seconds. After the treatment, excessive polyvinyl phosphonic acid is removed from the surface preferably through washing or squeegeeing. After that, it is preferred that the plate is dried at preferably from 20 to 95° C.

In the invention, the coating amount of the resulting aluminum plate is preferably from 3 to 20 mg/m², and more preferably from 4 to 15 mg/m², in view of an anti-stain property and printing durability. The intended coating amount can be obtained by selecting a polyvinyl phosphonic acid concentration, surface treatment temperature, surface treatment time and a combination thereof.

The phosphor atom content by atomic percentage (atm %) of the polyvinyl phosphonic acid layer formed on the aluminum plate surface is preferably from 3 to 15 atm %, and more preferably from 5 to 9 atm %.

The processing solution used in the invention will be explained below.

A developer used in the invention contains, as an inorganic alkali agent, sodium hydroxide, potassium hydroxide, or lithium hydroxide. These alkali agents may be used singly or in combination of two or more kinds thereof. The pH of the developer is an alkali solution having a pH of preferably from 8.5 to less than 13.0, and more preferably from 10.5 to 12.5. The image portions of a printing plate obtained by developing a light sensitive planographic printing plate material with a developer with a pH of less than 8.5 are low in mechanical strength and is likely to be abraded during printing, resulting in lowering of printing durability. Further, the resulting image portions are chemically low, and are low in resistance to chemicals such as ink cleaning agent or a plate cleaner used in printing, resulting in poor chemical resistance. In contrast, a developer with a pH of from more than 13.0 shows strong skin irritation and must be carefully handled, and such a developer is undesired.

In addition to the alkali agents described above, the developer preferably contains buffering agents such as potassium silicate, sodium silicate, lithium silicate, ammonium silicate, potassium metasilicate, sodium metasilicate, lithium metasilicate, ammonium metasilicate, potassium phosphate, sodium phosphate, lithium phosphate, ammonium phosphate, potassium hydrogenphosphate, sodium hydrogenphosphate, lithium hydrogenphosphate, ammonium hydrogenphosphate, potassium carbonate, sodium carbonate, lithium carbonate, ammonium carbonate, potassium hydrogencarbonate, sodium hydrogencarbonate, lithium hydrogencarbonate, ammonium hydrogencarbonate, potassium borate, sodium borate, lithium borate and ammonium borate. These buffering agents are added to the developer in order to improve buffering effects and cleaning property of the printing plate surface.

Among these, potassium silicate or sodium silicate is preferred. The concentration of silicate in the developer is preferably from 1.0 to 3.0% by weight in terms of SiO₂ concentration. The ratio by mole (SiO₂/M) of SiO₂ to alkali metal M is preferably from 0.25 to 2.

An organic alkali reagent such as monomethylamine, dimethylamine, trimethylamine, monoethylamine, diethylamine, triethylamine, monoisobutylamine, diisobutylamine, triisobutylamine, n-butylamine, monoethanolamine, diethanolamine, triethanolamine, monoisopropanolamine, diisopropanolamine, ethyleneimine, ethylenediamine, or pyridine can be used in combination.

The electric conductivity of the developer used in the invention is from 10 to 30 mS/cm. A developer with an electric conductivity of less than 10 mS/cm is low in alkalinity, resulting in insufficient development. A developer with an electric conductivity exceeding 30 mS/cm is too high in alkalinity, and damages image portions of printing plate, resulting in insufficient printing durability. This developer has high salt concentration and is likely to cause salting out, i.e., produce precipitations which contaminate non-image portions of printing plate.

The developer in the invention refers to a developer (so-called working developer) replenished with developer replenisher in order to maintain activity of the developer which lowers during development of light sensitive planographic printing plate material, as well as fresh developer used at the beginning of development. The developer replenisher is required to be higher in activity (for example, in alkali agent concentration) than the working developer, and may have a pH exceeding 13.0.

The developer in the invention preferably contains a surfactant having a polyoxyalkylene group. It is preferred that a nonionic surfactant, an anionic surfactant and a polymer surfactant are used singly or in combination.

As a nonionic surfactant having a polyoxyalkylene group is suitably used a compound represented by the following formula (1),

R₁₁—O—(R₁₂—O)ₙH Formula (1)

wherein R₁₁ is an alkyl group having 3 to 15 carbon atoms, an aromatic hydrocarbon group having 6 to 16 carbon atoms or an aromatic heterocyclic group having 4 to 15 carbon atoms, each of which may have a substituent, (examples of the substituent include an alkyl group having 1 to 20 carbon atoms, a halogen atom such as Br, Cl or I, an aromatic hydrocarbon group having 6 to 15 carbon atoms, an aralkyl group having 7 to 17 carbon atoms, an alkoxy group having 1 to 20 carbon atoms, an alkoxycarbonyl group having 2 to 20 carbon atoms and an acyl group having 2 to 15 carbon atoms); R₁₂ is an alkylene group having 1 to 100 carbon atoms, which may have a substituent (examples of the substituent include an alkyl group having 1 to 20 carbon atoms and an aromatic hydrocarbon group having 6 to 15 carbon atoms); and n is an integer of 1 to 100.

In formula (1), (R₁₂—O)ₙ may be comprised of a combination of two or three kinds thereof, as long as it falls within the above-described range. Typical examples thereof include those in which a combination of an ethyleneoxy group and a propyleneoxy group, an ethyleneoxy group and an isopropyleneoxy group, an ethyleneoxy group and butyleneoxy group, or an ethyleneoxy group and an isobutyleneoxy group is arranged randomly or in block form.

As an anionic surfactant having a polyoxyalkylene group is suitably used a compound represented by the following formula (2),

R₁₃—O—(R₁₄—O)ₘ—SO₃X Formula (2)

wherein R₁₃ is an alkyl group having 3 to 15 carbon atoms, an aromatic hydrocarbon group having 6 to 16 carbon atoms or an aromatic heterocyclic group having 4 to 15 carbon atoms, each of which may have a substituent, (examples of the substituent include an alkyl group having 1 to 20 carbon atoms, a halogen atom such as Br, Cl or I, an aromatic hydrocarbon group having 6 to 15 carbon atoms, an aralkyl group having 7 to 17 carbon atoms, an alkoxy group having 1 to 20 carbon atoms, an alkoxycarbonyl group having 2 to 20 carbon atoms and an acyl group having 2 to 15 carbon atoms); R₁₄ is an alkylene group having 1 to 100 carbon atoms, which may have a substituent (examples of the substituent include an alkyl group having 1 to 20 carbon atoms and an aromatic hydrocarbon group having 6 to 15 carbon atoms); and m is an integer of 1 to 100.

In formula (2), (R₁₄—O)ₘ may be comprised of a combination of two or three kinds thereof, as long as it falls within the above-described range. Typical examples thereof include those in which a combination of an ethyleneoxy group and a propyleneoxy group, an ethyleneoxy group and an isopropyleneoxy group, an ethyleneoxy group and butyleneoxy group, or an ethyleneoxy group and an isobutyleneoxy group is arranged randomly or in block form. Surfactants having a polyoxyalkylene group, which may be used alone or in their combination, are added to a developer, in an amount of preferably 1 to 30%, and more preferably 2 to 20% by weight. A lesser addition amount lowers developability and an excessive addition results in increased damages in development, leading to lowering of printing durability of printing plate.

The polymer surfactant may be any, as long as they have a polyoxyalkylene group with a carbon atom number of from 2 to 4. The polymer surfactant is preferably a polyoxyethylene polyoxypropylene block copolymer or a polyoxyethylene polyoxypropylene alkyl ether

The polyoxyethylene polyoxypropylene block copolymer has the following structure:

HO(CH₂H₄O)a(CH₃H₆O)b(CH₂H₄O)cH

In the above formula, a, b and c independently represent an integer of from 1 to 1000.

The above copolymer is preferably a copolymer in which the ethylene oxide content is from 10 to 90% by weight and preferably from 40 to 80% by weight, and the molecular weight of the propylene oxide is from 1000 to 4000 and preferably from 2000 to 3500.

The developer used in the invention can contain various surfactants other than the nonionic surfactant, the anionic surfactant and the polymer surfactant described above, in order to accelerate development, disperse smuts occurring during development, or enhance ink receptivity at the image portions of printing plate.

As such surfactant, there are an anionic surfactant, a cationic surfactant, a nonionic surfactant, and an amphoteric surfactant. Preferred examples of the nonionic surfactant include polyoxyethylenealkyl ethers, polyoxyethylenealkylphenyl ethers, polyoxyethylene-polystyrylphenyl ethers, polyoxyethylenepolyoxypropylenealkyl ethers, partial esters of glycerin and fatty acids, partial esters of sorbitan and fatty acids, partial esters of pentaerythritol and fatty acids, propylene glycol monofatty acid ester, partial esters of sucrose and fatty acids, partial esters of polyoxyethylenesorbitan and fatty acids, partial esters of polyoxyethylenesorbitol and fatty acids, esters of polyoxyethylene glycol and fatty acids, partial esters of polyglycerin and fatty acids, polyoxyethylene castor oil, partial esters of polyoxyethyleneglycerin and fatty acids, polyoxyethylene-polyoxypropylene block copolymer, adduct of polyoxyethylene-polyoxypropylene block copolymer with ethylene imine, fatty acid diethanolamides, N,N-bis-2-hydroxyalkylamines, polyoxyethylenealkylamines, triethanolamine fatty acid esters, and trialkylamine oxides. Examples of the anionic surfactant include fatty acid salts, abietic acid salts, hydroxyalkane sulfonic acid salts, alkane sulfonic acid salts, dialkylsulfosuccinic acid salts, straight-chained alkylbenzene sulfonic acid salts, branched alkylbenzene sulfonic acid salts, alkylnaphthalene sulfonic acid salts, alkyldiphenylether sulfonic acid salts, alkylphenoxypolyoxyethylenepropyl sulfonic acid salts, polyoxyethylenealkyl sulfophenylether salts, N-methyl-N-oleiltaurine sodium salts, N-alkylsulfosuccinic acid monoamide disodium salts, petroleum sulfonic acid salts, nitrated castor oil, sulfated beef tallow, fatty acid alkyl ester sulfate salts, alkylsulfate salts, polyoxyethylenealkylethersulfate salts, fatty acid monoglyceride sulfate salts, polyoxyethylenealkylphenylethersulfate salts, polyoxyethylenestyrylphenylethersulfate salts, alkylphosphate salts, polyoxyethylenealkyletherphosphate salts, polyoxyethylenealkylphenyletherphosphate salts, partial saponification products of styrene-maleic anhydride copolymers, partial saponification products of olefin-maleic anhydride copolymers, and condensates of naphthalene sulfonic acid salts with formalin. Examples of the cationic surfactant include alkylamine salts, quaternary ammonium salts such as tetrabutylammonium bromide, polyoxyethylene alkylamine salts, and polyethylene polyamine derivatives. Examples of the amphoteric surfactant include carboxybetains, amino carboxylic acids, sulfobetaines, aminosulfates and imidazolines.

Surfactants, in which the polyoxyethylene in the surfactants described above is replaced by polyoxypropylene or polyoxybutylene can be also used.

These surfactants can be used singly or as a mixture of two or more thereof. The content of these surfactants in the developer is preferably from 0.05 to 10% by weight, and more preferably from 0.1 to 5% by weight.

The developer in the invention may contain additives such as water softeners. Examples of the water softeners include polyphosphoric acid or its sodium, potassium or ammonium salt; aminopolycarboxylic acids or their salts such as ethylenediaminetetraacetic acid or its sodium, potassium or ammonium salt, diethylenetriaminepentaacetic acid or its sodium, potassium or ammonium salt, triethylenetetraminehexaacetic acid or its sodium, potassium or ammonium salt, hydroxyethylethylene-diaminetriacetic acid or its sodium, potassium or ammonium salt, nitrilotriacetic acid or its sodium, potassium or ammonium salt, 1,2-diaminocyclohexane-tetraacetic acid or its sodium, potassium or ammonium salt, 1,3-diamino-2-propanoltetraacetic acid or its sodium, potassium or ammonium salt; and phosphonic acids or their salts such as aminotri(methylenephosphonic acid) or its sodium, potassium or ammonium salt, ethylenediaminetetra-(methylenephosphonic acid) or its sodium, potassium or ammonium salt, diethylenetriaminepenta(methylenephosphonic acid) or its sodium, potassium or ammonium salt, triethylenetetraminehexa(methylenephosphonic acid) or its sodium, potassium or ammonium salt, hydroxyethyl-ethylenediaminetri(methylenephosphonic acid) or its sodium, potassium or ammonium salt, and 1-hydroxyethane-1,1-diphosphonic acid or its sodium, potassium or ammonium salt. The water softener content of the developer varies on hardness or amount of a hard water used, but the content is preferably 0.01 to 5 weight %, and more preferably 0.01 to 0.5 weight %. The content less than the above range cannot attain the desired objects while the content exceeding the above range has an adverse effect on image areas such as dye elimination.

It is preferred that the light sensitive planographic printing plate material of the invention is developed employing an automatic developing machine.

It is preferred that a means for replenishing a developer replenisher in a necessary amount, a means for discharging any excessive developer, or a means for automatically replenishing water in necessary amounts is attached to the development section of the automatic developing machine. The automatic developing machine preferably comprises a means for detecting a transported planographic printing plate precursor, a means for calculating the area of the planographic printing plate precursor based on the detection, or a means for controlling the replenishing amount of a developer replenisher, the replenishing amount of water to be replenished or the replenishing timing. It is also preferred that the automatic developing machine comprises a means for detecting a pH, temperature and/or electric conductivity of developer, or a means for controlling the replenishing amount of developer replenisher, the replenishing amount of water to be replenished or the replenishing timing, based on the detection. The automatic developing machine preferably has a system of diluting the developer concentrate with water and of stirring the diluted concentrate. Where the developing step is followed by a washing step, washing water used for washing can be reused as dilution water for diluting the developer concentrate.

The automatic developing machine used in the invention may be provided with a pre-processing section to allow the plate to be immersed in a pre-processing solution prior to development. The pre-processing section is provided preferably with a mechanism of spraying a pre-processing solution onto the plate surface, preferably with a mechanism of controlling the pre-processing solution at a temperature within the range of 25 to 55° C., and preferably with a mechanism of rubbing the plate surface with a roller-type brush. Common water and the like are employed as the pre-processing solution.

The developed printing plate material is preferably subjected to post-processing. The post-processing step comprises post-processing the developed precursor with a post-processing solution such as washing water, a rinsing solution containing a surfactant, a finisher or a protective gumming solution containing gum arabic or starch derivatives as a main component. The post-processing step is carried out employing an appropriate combination of the post-processing solution described above. For example, a method is preferred in which a developed planographic printing plate precursor is post-washed with washing water, and then processed with a rinsing solution containing a surfactant, or a developed planographic printing plate precursor is post-washed with washing water, and then processed with a finisher, since it reduces fatigue of the rinsing solution or the finisher. It is preferred that a multi-step countercurrent processing is carried out employing a rinsing solution or a finisher. The post-processing is carried out employing an automatic developing machine having a development section and a post-processing section. In the post-processing step, the developed printing plate is sprayed with the post-processing solution from a spray nozzle or is immersed into the post-processing solution in a post-processing tank. A method is known in which supplies a small amount of water onto the developed printing plate precursor to wash the precursor, and reuses the water used for washing as a dilution water for developer concentrate. In the automatic developing machine, a method is applied in which each processing solution is replenished with the respective processing replenisher according to the area of the printing plate precursor to have been processed or the operating time of the machine. A method (use-and-discard method) can be applied in which the developed printing plate material is processed with fresh processing solution and discarded. The thus obtained planographic printing plate is mounted on a printing press, and printing is carried out.

Gum solution may be suitably added with acids or buffers to remove from the developed plate alkaline ingredients which are contained in the developer. Further, there may be added a hydrophilic polymer compound, a chelating agent, a lubricant, an antiseptic and a solubilizing agent. Inclusion of the hydrophilic polymer compound in the gum solution provides a function as a protecting agent to prevent the developed plate from flawing or staining.

Addition of a surfactant to the gum solution used in this invention improves the surface form of the coated layer. As the surfactant, an anionic surfactant and/or a nonionic surfactant can be used. Examples of the anionic surfactant include fatty acid salts, abietic acid salts, hydroxyalkanesulfonic acid salts, alkanesulfonic acid salts, dialkylsulfosuccinic acid salts, straight chain alkylbebzenesulfonic acid salts, branched alktlbebzenesulfonic acid salts, alkylnaphthalenesulfonic acid salts, alkylphenoxypolyoxyethylene propylsulfonic acid salts, polyoxyethylene alkylsulfophenyl ether, polyoxyethylene aryl ether sulfonic acid salts, polyoxyethylene-naphthyl ether sulfonic acid salts, N-metyl-N-oleyltaurine sodium salts, petroleum sulfonic acid salts, nitrated castor oil, sulfated tallow oil, fatty acid alkyl ester sulfuric acid ester salts, alkylnitrates, polyoxyethylene alkyl ether sulfuric acid ester salts, fatty acid monoglyceride sulfate ester salts, polyoxyethylene alkylphenyl ether sulfuric acid salts, alkylphosphate ester salts, polyoxyethylene alkyl ether phosphoric acid ester salts, polyoxyethylene alkylphenyl ether phosphoric acid ester salts, partially saponified styrene anhydrous maleic acid copolymer, partially saponified olefin-anhydrous maleic acid copolymer, and naphthalenesulfonic acid salt-formaline condensates. Of the foregoing, dialkylsulfosuccinic acid salts, alkylsulfates and alkylnaphthalenesulfonic acid salts are preferred.

Examples of the nonionic surfactant include polyoxyethylene alkyl ethers, polyoxyethylene alkylphenyl ethers, polyoxyethylene-polyoxypropylene block polymers, polyoxyethylene aryl ethers, polyoxyethylene naphthyl ethers, polyoxyethylene polystyrylphenyl ethers, polyoxyethylene polyoxypropylene alkyl ethers, glycerin fatty acid partial esters, sorbitan fatty acid partial esters, pentaerythritol fatty acid partial esters, propylene glycol monofatty acid esters, sugar fatty acid partial esters, polyoxuethylen sorbitan fatty acid partial esters, polyoxyethylene sorbitol fatty acid partial esters, polyethylene glycol fatty acid partial esters, polyglycerin fatty acid partial esters, polyoxyethylene-modified caster oils, polyoxyethylene grycerin fatty acid partial esters, fatty acid diethanolamides, N,N-bis-2-hydroxyalkylamines, polyoxyethylene alkylamine, triethanolamine fatty acid esters and trialkylamineoxides. Of the foregoing, polyoxyethylene alkylphenyl ethers and polyoxyethylene-polyoxypropylene block polymers are preferred. There are also usable fluorinated or silicone-type anionic or nonionic surfactants. The surfactants may be used as a mixture of two or more kinds thereof. For example, a combination of at least two different anionic surfactants or a combination of at least one anionic surfactant and at least one nonionic surfactant is preferred. The surfactant content is not specifically limited, but is preferably 0.01 to 20% by weight of post-processing solution.

In addition to the above ingredients, the gum solution used in the invention may contain polyhydric alcohols, alcohols or aliphatic hydrocarbons, as a lubricant. Preferred examples of the polyhydric alcohols include ethylene glycol, diethylene glycol, triethylene glycol, propylene glycol, tetraethylene glycol, polyethylene glycol, glycerin, and sorbitol. Preferred alcohols include, for example, alkyl alcohols such as propyl alcohol, butyl alcohol, pentanol, hexanol, butanol, and octanol; and alcohols containing an aromatic ring, such as benzyl alcohol, phenoxyethanol, and phenylaminoethyl alcohol.

Preferred examples of the aliphatic hydrocarbons include n-hexanol, methylamylalcohol, 2-ethylbutanol, n-heptanol, 3-heptanol, 2-octanol, 2-ethylhexanol, nonanol, 3,5,5-trimethylhexanol, n-decanol, undecanol, n-dodecanol, trimethylnonyl alcohol, tetradecanol, heptadecanol, 2-ethyl-1,3-hexanediol, 1,6-hexanediol, 2,5-hexanediol, 2,4-hexanediol, 1,8-octanediol, 1,9-nonanediol, and 1,10-decanediol. The content of the lubricant in the gum solution is preferably from 0.1 to 50% by weight, and more preferably from 0.5 to 3.0% by weight.

The gum solution used in the invention may contain a wetting agent. Preferred examples of the wetting agent include ethylene glycol, propylene glycol, triethylene glycol, butylene glycol, hexylene glycol, diethylene glycol, dipropylene glycol, glycerin, trimethylolpropane and diglycerin. The wetting agents may be used alone or as a mixture of two or more kinds thereof. The content of the wetting agent in the gum solution is preferably from 1 to 25% by weight.

There may be contained a variety of hydrophilic polymers for the purpose of enhancing film-forming ability. Any hydrophilic polymer which has been usable in a conventional gum solution is suitably usable. Examples thereof include gum Arabic, cellulose derivatives (e.g., carboxymethyl cellulose, carboxymethyl cellulose, methyl cellulose) and their modified compounds, polyvinyl alcohol and its derivatives, polyvinyl pyrrolidone, polyacrylamide and its copolymers, poly[(vinyl methyl ether)-co-(anhydrous maleic acid)], poly[(vinyl acetate)-co-(anhydrous maleic acid)], and poly[styrene-co-(anhydrous maleic acid)].

The gum solution in the invention is advantageously used within the acidic range of a pH of 3 to 6. Mineral acids, organic acids or inorganic salts are added to the post-processing solution to adjust the pH to the range of 3 to 6, preferably in an amount of 0.01 to 2% by weight. Mineral acids include, for example, nitric acid, sulfuric acid, phosphoric acid and metaphosphoric acid.

Organic acids include, for example, citric acid, acetic acid, oxalic acid, malonic acid, p-toluenesulfonic acid, tartaric acid, malic acid, lactic acid, levulinic acid, phytic acid and organic phosphonic acid. Inorganic salts include, for example, magnesium nitrate, primary phosphate, secondary phosphate, nickel sulfate, sodium hexamethanate, and sodium tripolyphosphate. Mineral acids, organic acids and inorganic salts may be used alone or as a mixture of two or more kinds thereof.

The gum solution may be added with antiseptics or defoaming agents. Examples of the antiseptics include phenol and its derivatives, formaline, imidazole derivatives, sodium dehydroacetate, 4-isothiazoline-3-one derivatives, benzoisothiazoline-3-one, benzotriazole derivatives, amidinoguanine derivatives, quaternary ammonium salts, derivatives of pyridine, quinoline and guanine, diazine, triazole derivatives, oxazole, and oxazine derivatives. A preferred content is a quantity capable of taking stable effect upon bacteria, mold or yeast, depending on the kind of bacteria, molds or yeast. The content is preferably 0.01 to 4% by weight, based on the working gum solution. Two or more antiseptic are preferably used as a mixture of two or more kinds thereof to take effects upon various kinds of bacteria or molds. Silicone defoaming agents are preferred, and any one of emulsion type and solubilization type is usable. A defoaming agent is used suitably at 0.01 to 1.0% by weight, based on the gum solution used.

Further, there may be added chelating agents. Preferred chelating agents include, for example, ethylenediaminetetraacetic acid and its sodium and potassium salts, diethylenetriaminepentaacetic acid and its sodium and potassium salts, triethylenetetraminehexaacetic acid and its sodium and potassium salts, ethylenediaminedisuccinic acid and its sodium and potassium salts, hydroxyethylethylenediaminetriacetic acid and its sodium and potassium salts, nitrilotriacetic acid and its sodium and potassium salts, and organic phosphonic acids or phosphonoalkanecarboxylic acids, such as 1-hydroxyethane-1,1-diphosphonic acid and its sodium and potassium salts, aminotri(methylenephosphonic acid) and its sodium and potassium salts. Besides the foregoing sodium and potassium salts of chelating agents, organic amine salts are also effective. Chelating agents are selected from those which can be stably present in the gum solution composition and is free from adverse effects on printing. The content thereof is preferably 0.001 to 1.0% by weight, based on the gum solution used.

In addition to the above ingredients, a lipophilicity-enhancing agent may be incorporated. Examples thereof include hydrocarbons such as turpentine oil, xylene, toluene, low heptane, solvent naphtha, kerosene, mineral spirit, petroleum fractions exhibiting a boiling point of ca. 120 to 250° C.; and plasticizers exhibiting a freezing point of 15° C. or less and a boiling point of 300° C. or more at 1 atmospheric pressure, including phthalic acid diesters such as dibutyl phthalate, diheptyl phthalate, di-n-octyl phthalate, di(2-ethylhexyl)phthalate, dinonyl phthalate, dodecyl dilauryl phthalate, and butylbenzyl phthalate; dibasic fatty acid esters, such as dioctyl adipate, butylglycol adipate, dioctyl azelate, dibutyl sebacate, di(2-ethylhexyl)sebacate, and diocyl sebacate; epoxy-modified triglycerides such as epoxy-modified soybean oil; phosphoric acid esters such as tricresyl phosphate, trioctyl phosphate, and triscrolethyl phosphate; and benzoic acid esters such as benzyl benzoate.

Further, there are included saturated fatty acids such as caproic acid, enatoic acid, heralgonic acid, capric acid, undecylic acid, lauric acid, tridecylic acid, myristic acid, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid, lacceric acid, and iso-valeric acid; and unsaturated fatty acids such as acrylic acid, crotonic acid, isocrotonic acid, undecylenic acidpleic acid, elaidic acid, cetoleic acid, nilcaic acid, btecidinic acid, sorbic acid, linolic acid, linolenic acid, arachidonic acid, propiolic acid, stearolic acid, sardine oil, tariric acid, and licanic acid. Of the foregoing, a fatty acid which is liquid at 50° C. is more preferred, one having 5 to 25 carbons is still more preferred, and one having 8 to 21 carbons is most preferred. These lipophilicity-enhancing agents may be used alone or as a mixture of two or more kinds thereof. The content thereof is preferably 0.01 to 10%, and more preferably 0.05 to 5% by weight, based on the gum solution.

The lipophilicity-enhancing agents may be incorporated through solution in the oil phase of a gum emulsion. Alternatively, they may be solubilized with the aid of a solubilizing agent.

In the invention the solid concentration of the gum solution usable in this invention is preferably 5 to 30 g/l. A gum layer thickness can be controlled by conditions of a squeezing means of a processor. The gum coverage is preferably 1 to 10 g/m². The gum coverage of more than 10 g/m² necessitates drying the plate surface at a relatively high temperature to complete drying for a short period, which is disadvantageous in terms of cost and safety, and whereby effects of this invention cannot be sufficiently achieved. A gum coverage of less than 1 g/m² results in non-uniform coating and unstable processability.

In the invention, the time from completion of coating the gum solution to start of drying is preferably 3 sec. or less, and more preferably 2 sec. or less. The shorter time enhances ink affinity.

The drying time is preferably 1 to 5 sec. Effects of this invention cannot be achieved at a drying time of more than 5 sec. A drying time of less than 1 sec. necessitates raising the plate surface temperature to sufficiently dry the lithographic printing plate, leading to disadvantages in cost and safety.

In the invention, known drying methods using a hot air heater or a far-infrared heater are applicable in this invention.

In the drying stage, solvents included in the gum solution need to be dried, necessitating securing sufficient drying temperature and heater capacity. The temperature needed for drying depends on the composition of the gum solution. In the case of the solvent of the gum solution being water, for example, the drying time is preferably 55° C. or more. The capacity is preferably at least 2.6 kW in a hot air drying system. A larger capacity is desirable and a capacity of 2.6 to 7 kW is preferred in balance with cost.

It is preferred in the invention that the planographic printing plate material is washed with a washing solution prior to development. The washing solution used prior to development is usually common water and may be a solution in which additives such as chelating agents, surfactants or antiseptics are added to water.

The chelating agents are used which are capable of coordination-bonding with a metal ion to form a chelate compound. Examples of the chelating agents include ethylenediaminetetraacetic acid and its potassium and sodium salts, ethylenediaminedisuccinic acid and its potassium and sodium salts, triethylenetetraminehexaacetic acid and its sodium and potassium salts, diethylenetriaminepentaacetic acid and its sodium and potassium salts, hydroxyethylethylenediaminetriacetic acid and its sodium and potassium salts, nitrilotriacetic acid and its sodium and potassium salts, 1-hydroxyethane-1,1-diphosphonic acid and its sodium and potassium salts, aminotri(methylenephosphonic acid) and its sodium and potassium salts and phosphonoalkanetricarboxylic acid. Besides the sodium and potassium salts of chelating agents, their organic amine salts are also effective. These chelating agents are contained in an amount of 0 to 3.0% by weight.

The surfactants include any one of anionic, nonionic, cationic and amphoteric surfactants, and anionic and nonionic surfactants are preferably used. The kind of preferred surfactants is different depending on the composition of an over-coat layer or photosensitive layer. In general are preferred surfactants which are capable of promoting dissolution of material used in the over-coat layer and exhibit less solubility for components of the photosensitive layer.

Examples of the anionic surfactants include fatty acid salts, abietic acid salts, hydroxyalkanesulfonates, alkanesulfonates, dialkylsulfosuccinates, straight chain alkylbebzenesulfonates, branched alktlbebzenesulfonates, alkylnaphthalenesulfonates, alkylphenoxypolyoxyethylene propylsulfonates, polyoxyethylene alkylsulfophenyl ether, polyoxyethylene aryl ether sulfonic acid salts, polyoxyethylene-naphthyl ether sulfonic acid salts, N-metyl-N-oleyltaurine sodium salts, petroleum sulfonic acid salts, nitrated castor oil, sulfated tallow oil, fatty acid alkyl ester sulfuric acid ester salts, alkylnitrates, polyoxyethylene alkyl ether sulfuric acid ester salts, fatty acid monoglyceride sulfate ester salts, polyoxyethylene alkylphenyl ether sulfuric acid salts, alkylphosphate ester salts, polyoxyethylene alkyl ether phosphoric acid ester salts, polyoxyethylene alkylphenyl ether phosphoric acid ester salts, partially saponified styrene anhydrous maleic acid copolymer, partially saponified olefin-anhydrous maleic acid copolymer, and naphthalenesulfonate formaline condensates. Of the foregoing, dialkylsulfosuccinates, alkylsulfates and alkylnaphthalenesulfonates are preferred.

Examples of the nonionic surfactants include polyoxyethylene alkyl ethers, polyoxyethylene alkylphenyl ethers, polyoxyethylene-polyoxypropylene block polymers, polyoxyethylene aryl ethers, polyoxyethylene naphthyl ethers, polyoxyethylene polystyrylphenyl ethers, polyoxyethylene polyoxypropylene alkyl ethers, glycerin fatty acid partial esters, sorbitan fatty acid partial esters, pentaerythritol fatty acid partial esters, propylene glycol monofatty acid esters, sugar fatty acid partial esters, polyoxuethylen sorbitan fatty acid partial esters, polyoxyethylene sorbitol fatty acid partial esters, polyethylene glycol fatty acid partial esters, polyglycerin fatty acid partial esters, polyoxyethylene-modified caster oils, polyoxyethylene grycerin fatty acid partial esters, fatty acid diethanolamides, N,N-bis-2-hydroxyalkylamines, polyoxyethylene alkylamine, triethanolamine fatty acid esters and trialkylamineoxides. The surfactant is contained preferably in an amount of 0 to 10% by weight. The surfactant may be used in combination with defoaming agents.

The antiseptics include, for example, phenol and its derivatives, formalin, imidazole derivatives, sodium dehydroacetate, 4-isothiazoline-3-one derivatives, benzoisothiazoline-3-one, benzotriazole derivatives, amidinoguanine derivatives, quaternary ammonium salts, derivatives of pyridine, quinoline and guanine, diazine, triazole derivatives, oxazole, and oxazine derivatives.

The washing solution used prior to development is used preferably at a controlled temperature, and more preferably at 10 to 60° C. Washing can be performed using commonly known solution-feeding techniques such as a spraying, dipping or coating method. During washing, a wash promoting method employing a brush, a squeezing roll or a submerged shower in a dipping treatment can be suitably used.

Development may be conducted, immediately after the washing prior to development. Alternatively, development may be performed, after drying is conducted after the washing. The development is followed by a post-treatment such as washing, rinsing or a gumming treatment. Washing water used prior to development may also be reused as washing water or for a rinsing solution or gumming solution.

### EXAMPLES

Next, the present invention will be explained employing examples, but the present invention is not limited thereto. In the examples, “parts” represents “parts by weight”, unless otherwise specified.

### Example 1

### (Preparation of Aluminum Support)

Employing a continuous aluminum plate processing apparatus, a 0.24 mm thick and 1030 mm wide aluminum (according to JIS 1050) plate was subjected to the following continuous processing.

(a) The aluminum plate was sprayed with a solution containing 2.6% by weight of sodium hydroxide and 6.5% by weight of aluminum ion at 70° C. to dissolve out 0.3 g/m² of aluminum, and then washed with water by spraying.

(b) The resulting aluminum plate was subjected to desmut treatment by spraying a 70° C. 1% by weight nitric acid aqueous solution (containing 0.5% by weight of aluminum), and then washed with water by spraying.

(c) The resulting plate was continuously subjected to electrochemically surface-roughening treatment, employing alternating voltage of 60 Hz, and then washed with water by spraying. The electrolyte solution used contained 1.1% by weight of hydrochloric acid, 0.5% by weight of aluminum, and 0.5% by weight of acetic acid. The surface treatment temperature was 21° C. The electrochemical treatment was carried out employing sine-wave alternating current of a TP of 2 msec and a carbon electrode as a counter electrode. Herein, TP implies time taken until the current arrives at peak from zero. The current density (effective current density) was 50 A/dm², and quantity of electricity was 900 C/dm².

(d) The resulting plate was subjected to desmut treatment for 10 seconds, employing a 60° C. 20% by weight phosphoric acid aqueous solution containing 0.5% by weight of aluminum, and then washed with water by spraying.

(e) The resulting plate was subjected to anodization treatment in 38° C. 170 g/liter sulfuric acid solution containing 0.5% by weight of aluminum, employing an anodization apparatus with two electricity supply sections and two electrolytic sections (length of the first and second electrolytic sections: 6 m, length of the first and second electricity supply sections: 3 m, length of a first electricity supply electrode in the first electricity supply section and a second electricity supply electrode in the second electricity supply section: 2.4 m), and then washed with water by spraying.

Herein, current from a power supply flows to the first electricity supply electrode provided in the first electricity supply section, flows to the aluminum plate through the electrolyte solution, forms an anodization film on the aluminum surface at the first electrolytic section, passes through the electrode in the first electricity supply section, and returns to the power supply.

Current from a power supply flows to the second electricity supply electrode provided in the second electricity supply section, flows to the aluminum plate through the electrolyte solution, and forms an anodization film on the aluminum surface at the second electrolytic section. Quantity of electricity supplied to the first electricity supply section from the power supply is the same as that supplied to the second electricity supply section from the power supply. Current density at the anodization film surface in the second electricity supply section was approximately 25 A/dm². In the second electricity supply section, electricity was supplied from the anodization film with a thickness of 1.35 g/m².

The final anodization film thickness was 2.7 g/m². The resulting aluminum plate was washed by spraying water, immersed for 30 seconds at 75° C. in a 0.4% by weight polyvinyl phosphonic acid aqueous solution, spray-washed with water, and dried with an infrared heater, whereby hydrophilization treatment was conducted. Thus, an aluminum support was obtained.

The aluminum support obtained above had a center-line average surface roughness (Ra) of 0.65 μm.

### (Preparation of Light Sensitive Planographic Printing Plate Material Samples)

The following light sensitive layer coating solution was coated on the aluminum support obtained above through a wire bar, and dried at 90° C. for 1.5 minutes to give a light sensitive layer having a dry thickness of 1.8 g/m². The contact angle of 25° C. water of the light sensitive layer (hereinafter also referred to simply as the contact angle) was adjusted as shown in Table 1.

The contact angle of 25° C. water to the light sensitive was determined employing a Kyowa contact angle meter CA-D (produced by Kyowa Kagaku Co., Ltd.).

After that, the following protective layer coating solution was coated on the resulting light sensitive layer using a wire bar, and dried for 1.5 minutes at a drying temperature as shown in Table 1 to give a protective layer with a dry thickness of 1.9 g/m². Thus, inventive light sensitive planographic printing plate material samples 1 through 10 and comparative light sensitive planographic printing plate material samples 1 through 4 were prepared.

| (Light sensitive layer coating solution) | | |
|---|---|---|
| *Polymeric binder A (as described below) | 40 | parts |
| Compound B (Addition polymerizable ethylenically unsaturated compound described below) | 44 | parts |
| Polyethylene glycol dimethacrylate NK ESTER 3G (produced by Shinnakamura Kagaku Co., Ltd.) | 4.0 | parts |
| Spectral sensitizing dye (D) described below | 4.0 | parts |
| Polymerization initiator (I) described below | 1.5 | parts |
| Trihaloalkyl compound (C) described below | 0.5 | parts |
| Compound (T) described below | 1.5 | parts |
| Hindered amine stabilizer (LS-770 produced by SANKYO LIFETECK CO., LTD.) | 0.5 | parts |
| **Metal-free phthalocyanine pigment particle dispersion solution described below (wherein the | 30 | parts |
| particles having an average particle size of 150 nm, and a content ratio of particles with a particle size of not more | | |
| than 500 nm being not more than 5%, based on the total weight of the particles) | | |
| Surfactant as shown in Table 1 (in terms of solid content) | 0.3 | parts |
| Methyl ethyl ketone | 30 | parts |
| Propylene glycol monomethyl ether acetate | 80 | parts |
| Propylene glycol monomethyl ether | 830 | parts |
| *Polymeric binder A: Methacrylic acid/methyl methacrylate/hydroxyethyl | | |
| methacrylate (15/75/10 by mole %) copolymer (having a weight average molecular weight of 50,000, an acid value of 90, and | | |
| a glass transition temperature of 120° C.) | | |
| **Metal-free phthalocyanine pigment dispersion solution: | | |
| Metal-free phthalocyanine pigment (PB16) | 10.0 | parts |
| Fluidizing agent (Solsperse 5000) | 0.5 | parts |
| Polymer dispersant (Solsperse 24000GR) | 1.5 | parts |
| Methyl ethyl ketone | 88.0 | parts |
| (Protective layer coating solution) | | |
| Polyvinyl alcohol (as shown in Table 1) | 85 | parts |
| Vinyl pyrrolidone-vinyl acetate copolymer | 14 | parts |
| (VA64W, produced by BASF Co., Ltd.) | | |
| Surfactant (Surfinol 465, produced by Nisshin Kagaku Kogyo Co., Ltd.) | 1.0 | part |
| Water | 900 | parts |

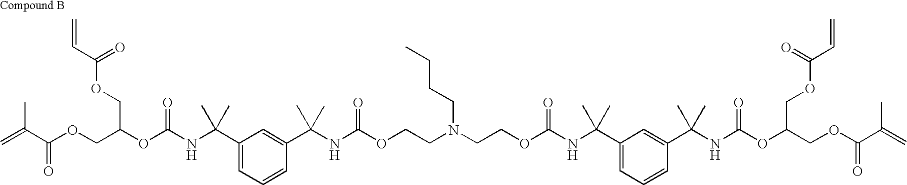

| | | |
|---|---|---|
| 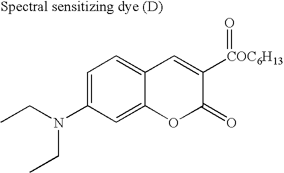 | 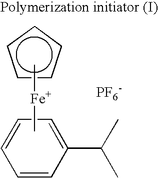 | 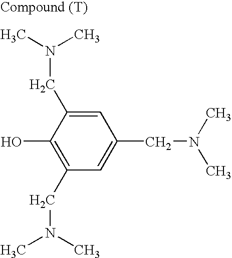 |

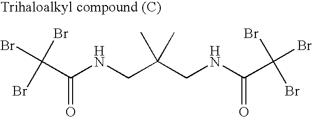

TABLE 1

| | LIGHT SENSITIVE | | | |
|---|---|---|---|---|
| | LAYER | | PROTECTIVE LAYER | |
| | Sur- | Contact | Polyvinyl alcohol | Drying |
| Sample | factant | angle | used (Degree of | Temperature |
| No. | used | (°) | saponification mol %) | (° C.) |
| 1 (Comp.) | BYK-337 | 85 | Celvo1203 (88) | 100 |
| 2 (Comp.) | BYK-337 | 85 | Celvo1103/ | 100 |
| | | | Celvo1203 (93) | |
| 1 (Inv.) | BYK-337 | 85 | Celvo1103/ | 100 |
| | | | Celvo1203 (94) | |
| 2 (Inv.) | BYK-337 | 85 | Celvo1103/ | 100 |
| | | | Celvo1203 (96) | |
| 3 (Inv.) | BYK-337 | 85 | Celvo1103 (98) | 100 |
| 4 (Inv.) | BYK-337 | 85 | Celvo1103 (98) | 75 |
| 5 (Inv.) | BYK-307 | 80 | Celvo1103 (98) | 100 |
| 6 (Inv.) | BYK-375 | 70 | Celvo1103 (98) | 100 |
| 3 (Comp.) | A | 91 | Celvo1103 (98) | 100 |
| 4 (Comp.) | None | 60 | Celvo1103 (98) | 100 |
| 7 (Inv.) | BYK-337 | 85 | PVA105 (98) | 100 |
| 8 (Inv.) | BYK-337 | 85 | PVA105/PVA205 (96) | 100 |
| 9 (Inv.) | BYK-337 | 85 | Mowio16–98 (98) | 100 |
| 10 (Inv.) | BYK-337 | 85 | Mowio13–96 (96) | 100 |

Comp.: Comparative,
Inv.: Inventive
A: F-178 K produced by Dainippon Ink Co., Ltd.

### Evaluations

### (Coatability of Protective Layer)

Coatability of the protective layer was visually observed, and evaluated according to the following evaluation criteria:

### 3: No repellent spots nor streaks were observed, and the surface protective layer was smooth.

### 2: Slightly greater thickness was observed at the ends in the width direction of the protective layer, although no repellent spots nor streaks were observed.

### 1: Repellent spots were observed, resulting in an uneven protective layer.

Ranks 2 and 3 are the level, which are put into practical use, but Rank 1 is not.

### (Adhesion)

Employing a scratch tester Heidon-18 (produced by Heidon Co., Ltd.), the resulting sample obtained above was scratched with a sapphire needle having a tip diameter of 0.1 mm, at a speed of 100 mm/min., and at 23° C. and 50% RH, while the load applied to the sapphire needle was changed from 0 to 100 g. The minimum load (g) at which the protective layer was peeled from the light sensitive layer was determined, and evaluated as a measure of the protective layer adhesion. The minimum load is preferably not less than 50 g.

### (Latent Image Regression Resistance)

Each of the resulting planographic printing plate material samples obtained above was divided into two specimens. One specimen was imagewise exposed at an exposure energy of 50 μJ/cm², at a resolving degree of 2400 dpi, and at 23° C. and 50% RH, employing a CTP exposure device (News CTP produced by ECRM Co., Ltd.) equipped with a 405 nm LD laser with an output power of 60 mW), stored for one hour in the dark, and then subjected to development. Herein, “dpi” represents the dot numbers per inch or 2.54 cm. The image pattern used for the exposure comprised a solid image and a square dot image with a screen number of 175 LPI and a 50% dot area. The other specimen, immediately after imagewise exposed, was subjected to development.

The development was carried out as follows:

The exposed specimens were subjected to development, employing a CTP automatic developing machine (Raptor Polymer 85 produced by G & J Inc.) to obtain a planographic printing plate. Herein, the developing machine comprised a pre-washing section for removing the protective layer before development, a preheating section for the printing plate material, a development section set charged with a developer having the following developer composition, a washing section for removing any residual developer on the developed sample, and a gumming section charged with a gumming solution (a solution obtained by diluting GW-3, produced by Mitsubishi Chemical Co., Ltd., with water by a factor of 2) for protecting the surface of the developed sample. The development time, during which the exposed specimens were in contact with the developer, was 18 seconds. Thus, planographic printing plate samples were obtained.

The 50% square dot area of the two samples was measured employing ccDot (produced Centurfax Co., Ltd.), and the difference |ΔDot 1| (%) between the two measurements was determined and evaluated as a measure of latent image regression resistance. The difference |ΔDot 1| (%) is preferably not more than 2%.

(Developer composition for 1 liter of developer)

| | |
|---|---|
| Buffering agent: potassium silicate A | 7.7% by weight |
| (containing 26.0% by weight of SiO₂ and | |
| 13.5% by weight of K₂O) | |
| Surfactant: polyoxyethylene (13) | 4.0% by weight |
| naphthyl ether sulfonate | |
| Chelating agent: | 0.058% by weight |
| Ethylenediaminetetraacetic acid disodium salt | |
| Potassium hydroxide | amount giving the |
| | following pH |

Water was added to make 1 liter of developer.

The concentration of SiO₂ was 2.0% by weight, and the pH of the developer was 12.5.

### (Sensitivity Variation Due to Humidity)

Each of the resulting planographic printing plate material samples obtained above was divided into four specimens. The four specimens were exposed in the same manner as above. The four exposed specimens were stored in the dark for 2 hours at: (a) 23° C. and 20%, (b) 23° C. and 40%, (c) 23° C. and 60%, and (d) 23° C. and 80%, respectively, and thereafter, subjected to development in the same manner as above. The 50% square dot area of the developed specimens was measured employing ccDot (produced Centerflux Co., Ltd.), and difference |ΔDot 2| (%) between the minimum and maximum of the four measurements was determined and evaluated as a measure of sensitivity variation due to humidity. The difference |ΔDot 2| is preferably not more than 2%.

The results are shown in Table 2.

TABLE 2

| | | | | Latent image | | | | | |
|---|---|---|---|---|---|---|---|---|---|
| | | | | regression | Sensitivity variation due to | | | | |
| | | | | resistance | humidity | | | | |
| Sample | | | Adhesion | \|ΔDot 1\| | | | | | \|ΔDot 2\| |
| No. | | Coatability | (g) | (%) | 20% RH | 40% RH | 60% RH | 80% RH | (%) |
| 1 | (Comp.) | 3 | 10 | 20 | 60 | 60 | 55 | 40 | 20 |
| 2 | (Comp.) | 3 | 20 | 10 | 60 | 60 | 58 | 50 | 10 |
| 1 | (Inv.) | 3 | 70 | 2 | 60 | 60 | 60 | 58 | 2 |
| 2 | (Inv.) | 3 | 80 | 2 | 60 | 60 | 60 | 58 | 2 |
| 3 | (Inv.) | 3 | 100 | 1 | 60 | 60 | 60 | 59 | 1 |
| 4 | (Inv.) | 3 | 90 | 2 | 60 | 60 | 60 | 58 | 2 |
| 5 | (Inv.) | 3 | 100 | 1 | 60 | 60 | 60 | 59 | 1 |
| 6 | (Inv.) | 3 | 100 | 1 | 60 | 60 | 60 | 60 | 0 |
| 3 | (Comp.) | 2 | 30 | 5 | 60 | 60 | 60 | 55 | 5 |
| 4 | (Comp.) | 1 | 100 | 2 | 60 | 60 | 58 | 58 | 2 |
| 7 | (Inv.) | 3 | 100 | 1 | 60 | 60 | 60 | 59 | 1 |
| 8 | (Inv.) | 3 | 80 | 2 | 60 | 60 | 60 | 58 | 2 |
| 9 | (Inv.) | 3 | 100 | 1 | 60 | 60 | 60 | 59 | 1 |
| 10 | (Inv.) | 3 | 80 | 2 | 60 | 60 | 60 | 58 | 2 |

Comp.: Comparative,
Inv.: Inventive

As is apparent from Table 2, the inventive light sensitive planographic printing plate material samples have a protective layer with good coatability and good adhesion to the light sensitive layer, and provide high latent image regression resistance and less sensitivity variation due to humidity, as compared with the comparative light sensitive planographic printing plate material samples.

What is claimed is:

1. A light sensitive planographic printing plate material comprising a support and provided thereon, a photopolymerizable light sensitive layer containing a siloxane surfactant and a protective layer containing one or more kinds of water-soluble polymers in that order, contact angle of 25° C. water to the light sensitive layer being in the range of 65 to 85°, wherein one of the water soluble polymers is polyvinyl alcohol having a degree of saponification of not less than 94 mol %.

2. The light sensitive planographic printing plate material of claim 1, wherein the protective layer further contains polyvinyl pyrrolidone or vinyl pyrrolidone copolymer.

3. The light sensitive planographic printing plate material of claim 1, wherein the siloxane surfactant is polyether modified dimethylpolysiloxane.

4. The light sensitive planographic printing plate material of claim 3, wherein the polyether modified dimethylpolysiloxane is dimethylpolysiloxane modified with polyethylene oxide, polypropylene oxide, polybutylene oxide or their combination.

5. The light sensitive planographic printing plate material of claim 1, wherein the siloxane surfactant content of the light sensitive layer is from 0.01 to 10% by weight.

6. The light sensitive planographic printing plate material of claim 1, wherein the polyvinyl alcohol content of the protective layer is from 65 to 85% by weight.

7. The light sensitive planographic printing plate material of claim 1, wherein the photopolymerizable light sensitive layer contains a polymeric binder having an acid value of from 30 to 120, a polymerizable ethylenically unsaturated compound, and a photopolymerization initiator.

8. The light sensitive planographic printing plate material of claim 7, wherein the polymerizable ethylenically unsaturated compound is a reaction product of (a) a polyhydric alcohol having a tertiary amino group in the molecule, (b) a diisocyanate and (c) a compound having a hydroxyl group and an ethylenically double bond in the molecule, and the photopolymerization initiator is selected from the group consisting of a titanocene compound, an iron-arene complex, a trihaloalkyl compound and a monoalkyltriaryl borate compound.

9. The light sensitive planographic printing plate material of claim 1, wherein the photopolymerizable light sensitive layer further contains a sensitizing dye.

10. A process for manufacturing the light sensitive planographic printing plate material of claim 1, the process the steps of:
forming a photopolymerizable light sensitive layer containing a siloxane surfactant on a support;
providing a protective layer coating liquid containing one or more kinds of water-soluble polymers, one of the water soluble polymers being polyvinyl alcohol having a degree of saponification of not less than 94 mol %;
coating the protective layer coating liquid on the resulting light sensitive layer; and
drying the coated protective layer at 95 to 120° C. to form a protective layer on the light sensitive layer.
